(19) United States
(12) Patent Application Publication
(10) Pub. No.: US 2026/0298344 A1
(43) Pub. Date: Oct. 1, 2026

(54) METHOD OF SEALING A FLUID LEAKAGE PATH

(71) Applicant: Origin Tech Ltd, Gateshead (GB)

(72) Inventor: John MARSDEN, Gateshead (GB)

(73) Assignee: ORIGIN TECH LTD, Gateshead (GB)

(21) Appl. No.: 19/477,973

(22) PCT Filed: Apr. 25, 2024
(86) PCT No.: PCT/EP2024/061405

§ 371 Date: Oct. 23, 2025

(30) Foreign Application Priority Data
Apr. 27, 2023 (GB) 2306255.7

(51) Int. Cl. F16J 15/14; C09K 3/12

(52) U.S. Cl. CPC F16J 15/14; C09K 3/12

(57) ABSTRACT

A method of sealing a fluid leakage path 106, such as a fluid leakage path through a wall 104 of a structure 102. In an embodiment, the method comprises supplying a loss control composition 114 to a region of a wall 104 of a structure 102 having a fluid leakage path 106 and causing the loss control composition 114 to enter and propagate along at least a portion of the fluid leakage path 106. The loss control composition 114 comprises a mixture of at least one fluid and particles of material 116a, 116b suspended in the fluid. The particles of material 116a, 116b are configured to become trapped within the fluid leakage path 106 as the loss control composition 114 propagates along the at least a portion of the fluid leakage path 106 such that the particles of material 116a, 116b accumulate within the fluid leakage path 106 thereby sealing the fluid leakage path 106.

### TECHNICAL FIELD

The present invention relates to a method of sealing a fluid leakage path, and particularly, although not exclusively, relates to a method of sealing a fluid leakage path through a wall of a structure such as a conduit, for example a pipe, or a vessel, for example a tank.

### BACKGROUND

There are many situations in which fluid leakage paths, such as a leakage path through a wall of a structure, are difficult to locate and/or difficult to access to carry out a repair. For example, pipes that buried or are submerged or which extend through structures, such as wall cavities, can be difficult to access in order to identify a location of a leakage path through a wall of a pipe and to carry out a repair.

Buried pipes typically have to be surveyed internally in order to identify the location of a leak and then excavated in order to carry out a repair. Similarly, structures through which pipes extend have to be dismantled or accessed using remote access systems in order to identify and then repair a leak.

For other structures, such as storage tanks, it can be difficult to access the location of a leak. Examples include tanks that are buried, or partially buried, and tanks that contain hazardous waste.

There is therefore a need for an improved method of sealing a fluid leakage path, such as a fluid leakage path through a wall of a structure such as a conduit, for example a pipe, or a vessel, for example a wall of a tank.

### SUMMARY OF THE INVENTION

According to a first aspect of the invention there is provided a method of sealing a fluid leakage path through a wall of a structure comprising the steps: supplying a loss control composition to a region of a wall of a structure having a fluid leakage path; and causing the loss control composition to enter and propagate along at least a portion of the fluid leakage path, the loss control composition comprising a mixture of at least one fluid and particles of material suspended in the fluid, wherein the particles of material are configured to become trapped within the fluid leakage path as the loss control composition propagates along the at least a portion of the fluid leakage path such that the particles of material accumulate within the fluid leakage path thereby sealing the fluid leakage path.

Optionally, the loss control composition further comprises a gelling agent which combines with the fluid to form a gel. Optionally, the fluid comprises a liquid. Optionally, the liquid comprises water.

Optionally, the loss control composition comprises not less than 1 part water, not less than 0.1 part particulate, and not less than 0.05 part gelling agent by mass.

Optionally, the loss control composition comprises not less than 1 part water, not more than 0.8 part particulate, and not more than 0.25 part gelling agent by mass.

Optionally, the gelling agent comprises at least one of a water-soluble gelling agent, an oil-based gelling agent and a polymer-based gelling agent.

Optionally, the particles of material comprise particles of material that have an elastic modulus not less than 5 GPa, and optionally not less than 20 GPa. Optionally, particles of mineral may be selected from particles of a material having an elastic modulus not less than 70 GPa. Optionally, particles of mineral may be selected from particles of a material having an elastic modulus not less than 70 GPa and not greater than 90 GPa.

Optionally, the particles of material comprise particles of material that are mineral.

Optionally, the loss control composition has a composition in which particles of material comprise particles of material having a particle size which is not greater than 5 mm.

Optionally, the loss control composition comprises a first sub-composition in which the particles of material have a particle size within a first predetermined range and a second sub-composition in which the particles of material have a particle size within a second predetermined range.

Optionally, the first predetermined range and the second predetermined range are non-overlapping ranges.

Optionally, the loss control composition comprises not less than 10% wt of the first sub-composition.

Optionally, the loss control composition comprises not more than 50% wt of the first sub-composition, and optionally not less than 50% wt of the first sub-composition.

Optionally, the loss control composition comprises not less than 30% wt of the second sub-composition, and optionally not less than 60% wt of the second sub-composition.

Optionally, the first sub-composition comprises particles having a particle size not greater than 5 mm. Optionally, the first sub-composition comprises particles having a particle size not less than 500 microns.

Optionally, the second sub-composition comprises particles having a particle size not greater than 250 microns. Optionally, the second sub-composition comprises particles having a particle size within a range that is not less than 15 microns.

Optionally, the fluid leakage path has a selected dimension and the first sub-composition of particles of material may have a particle size within a range that is not greater than the selected dimension and not less than 50% of the selected dimension. The selected dimension may be a width of the leakage path, such as an average width of the leakage path.

Optionally, the second sub-composition of particles of material may have a particle size which is not greater than 5% of the selected dimension. Optionally, the second sub-composition of particles of material may have a particle size which is not greater than 1.5% of the selected dimension.

Optionally, the particles of material are particles of a material having a density which is not less than 2700 kg/m\hat{ }3.

Optionally, the step of causing the loss control composition to propagate along at least a portion of the fluid leakage path comprises the step of pressurising the loss control composition to a pressure that is not less than a predetermined pressure.

Optionally, wherein the fluid leakage path has a depth which is not less than the a maximum particle size of the particles of material of the loss control composition.

According to a second aspect of the invention there is provided a method of sealing a fluid leakage path through a tank containing hazardous material, wherein the fluid leakage path extends through the hazardous material and a wall of the tank, the method comprising the steps: supplying a loss control composition to a region of the tank above an upper level of the hazardous material such that a layer of loss control composition accumulates on an upper surface of the hazardous material at least in the region of the fluid leakage path; and maintaining the layer of loss control composition on an upper surface of the hazardous material for at least a predetermined period of time such that the loss control composition enters and propagates along at least a portion of the fluid leakage path, the loss control composition comprising a mixture of at least one fluid and particles of material suspended in the fluid and the particles of material are configured to become trapped within the fluid leakage path as the loss control composition propagates along the at least a portion of the fluid leakage path such that the particles of material accumulate within the fluid leakage path thereby sealing the fluid leakage path.

Optionally, the tank contains a layer of protective liquid disposed above the hazardous material.

Optionally, the protective liquid is water. Optionally, the hazardous material comprises a sludge. Optionally, the sludge is a radioactive sludge comprising magnesium hydroxide.

The loss control composition may be a loss control composition in accordance with the loss control composition used in accordance with the first aspect of the invention. The loss control composition may, however, be configured to seal the fluid leakage paths through the tank containing the radioactive sludge by selection of particles of material having a suitable particle size and suitable amount of gelling agent, for example in accordance with the same principles of selection as the first embodiment of the invention. The optional features of the first aspect of the invention may therefore be applied, where suitable, to the second aspect the invention. Certain aspects of the invention provide a method of sealing a fluid leakage path, such as a fluid leakage path through a wall of a structure such as a conduit, for example a pipe, or a vessel, for example a tank, that is rapid and effective.

Certain aspects of the invention provide a method of sealing a fluid leakage path, such as fluid leakage path through a wall of a structure such as a conduit, for example a pipe, or a vessel, for example a tank, that does not require external access to the pipe in the vicinity of the fluid leakage path.

Certain aspects of the invention provide a method of sealing a fluid leakage path, such as fluid leakage path through a wall of a structure such as a conduit, for example a pipe, or a vessel, for example a tank, that does not utilise a material that must be cured.

Certain aspects of the invention provide a method of sealing a fluid leakage path, such as fluid leakage path through a wall of a structure such as a conduit, for example a pipe, or a vessel, for example a tank, which does not require a elastomeric material.

Certain aspects of the invention provide a method of sealing a fluid leakage path, such as fluid leakage path through a wall of a structure such as a conduit, for example a pipe, or a vessel, for example a tank, which does not rely on knowing the precise location of a leak.

Certain aspects of the invention provide a method of sealing a fluid leakage path, such as fluid leakage path through a tank containing hazardous material, wherein the fluid leakage path extends through the hazardous material and a wall of the tank, without having to empty the tank and which does not require external access to the tank.

Various further features and aspects of the invention are defined in the claims.

Unless defined otherwise, all technical and scientific terms used herein have the meaning commonly understood by a person skilled in the art to which this invention belongs.

### BRIEF DESCRIPTION OF THE DRAWINGS

Embodiments of the present invention will now be described by way of example with reference to the accompanying drawings where like parts are provided with corresponding reference numerals and in which:

FIG. 1a is a schematic illustration of a pipe having fluid leakage path through a wall of the pipe;

FIG. 1b is a schematic illustration of the pipe shown in FIG. 1a along A-A;

FIG. 2a shows a portion of the pipe shown in FIG. 1a having the fluid leakage path in more detail;

FIG. 2b shows a portion of the shown in FIG. 1b having the fluid leakage path in more detail;

FIG. 3 is a flow chart illustrating the steps of a method of sealing a fluid leakage path through the wall of a pipe;

FIG. 4 is a table showing examples of pipes and fluid leakage paths for which the method shown in FIG. 3 is suitable;

FIGS. 5a, 5b, and 5c are schematic illustrations of steps of the method shown in FIG. 3; FIG. 6 is a schematic illustration of a fluid leakage path which has been sealed by the method shown in FIG. 3;

FIG. 7 is a schematic illustration of a tank containing hazardous material having fluid leakage paths though the hazardous material and the tank;

FIG. 8 is a flow chart illustrating the steps of a method of sealing a leakage path through the tank shown in FIG. 7, and

FIGS. 9a and 9b are schematic illustrations of steps of the method shown in FIG. 8.

### DETAILED DESCRIPTION

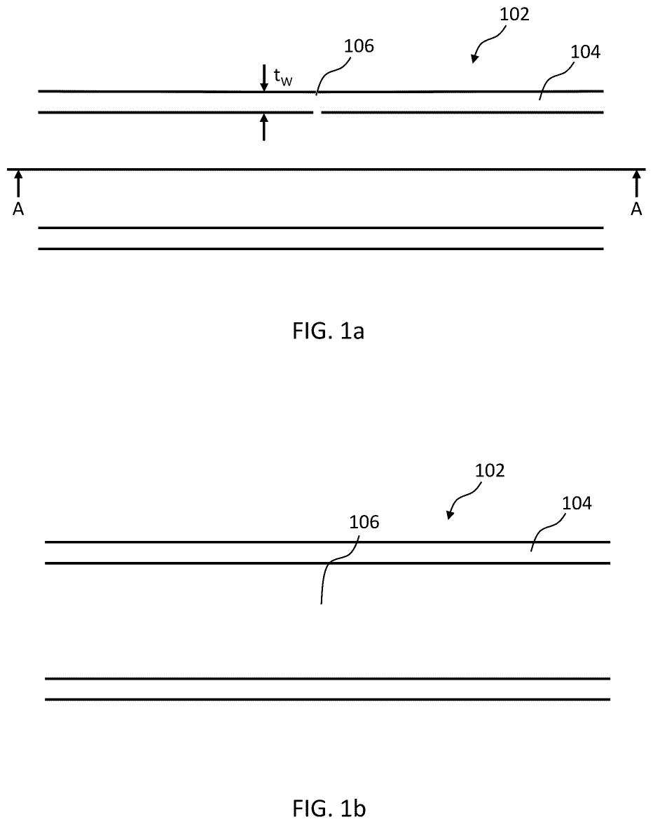

FIGS. 1a and 1b shows a structure in the form of a pipe 102 having a pipe wall 104. The pipe wall 104 has a local pipe wall thickness t_{W}. The pipe wall thickness t_{W} may be constant or vary along the length of the pipe 102. The pipe 102 may be manufactured from plastic (for example, polyurethane, alkathene or polyvinyl chloride), metal (for example, cast iron, ductile iron, galvanised iron, AC, copper or lead), concrete or other suitable material. The pipe 102 may be a water utility pipe or a pipe used to convey other fluids from one location to another, for example.

The pipe wall 104 has a fluid leakage path 106 through it. Fluid, such as water, conveyed by the pipe 102 leaks from the pipe 102 along the fluid leakage path 106 into the surrounding environment, such as surrounding earth, water or air. The fluid leakage path 106 may be a hole, crack or split in the pipe wall 104, but may also be a leakage path between joined components of the pipe, such as at a joint, flange connection, fitting or a threaded collar of a pipe.

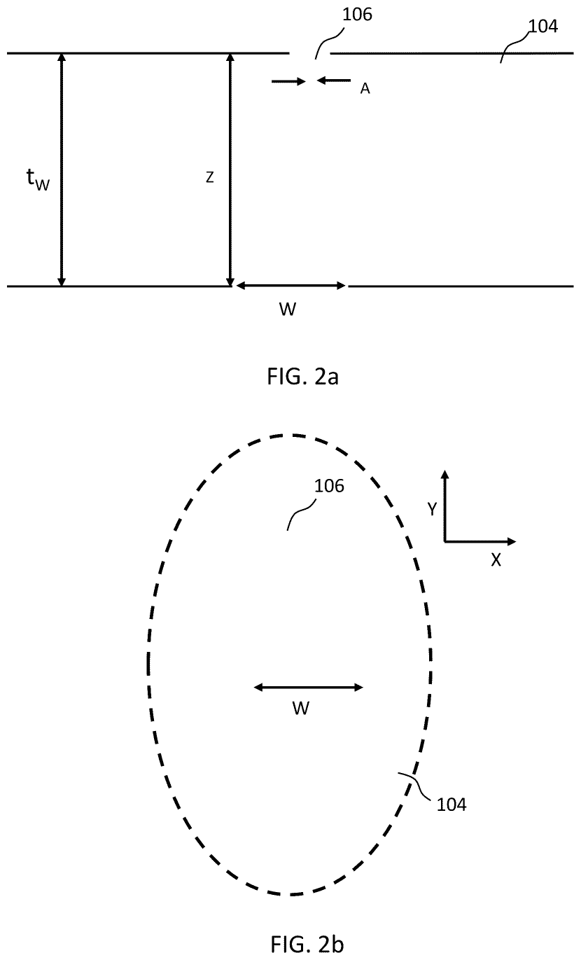

FIGS. 2a and 2b show the region of the pipe 102 shown in FIGS. 1a and 1b which has the fluid leakage path 106 through it. In the scenario shown, the fluid leakage path 106 is a crack that extends around a portion of the circumference of the pipe 102. The fluid leakage path 106 has an entrance opening at the internal wall of the pipe 102 and an exit opening at the external wall of the pipe 102.

Characterising a fluid leakage path, such as a crack, is imprecise owing to the irregular nature of leakage paths and the difficulty accessing them. However, it is typical to characterise a fluid leakage path by a flow area, such as the minimum flow area, of the fluid leakage path or by one or more dimensions of the fluid leakage path. The flow area of a fluid leakage path, for example, can then be estimated based on the type of pipe or structure and how cracks are likely to form, the location of the crack and/or the rate of leakage of a fluid from the pipe 102 through the fluid leakage path.

In the scenario shown, the crack 106 has a first axis X that extends parallel with the lengthwise direction of the pipe 102 and a second axis Y that extends at a tangent to a circumferential direction of the pipe 102. The crack 106 has a depth axis Z that that extends perpendicular to the lengthwise direction of the pipe 102. The crack 106 has a minimum flow area AM which is the flow area at the narrowest section of the crack 106.

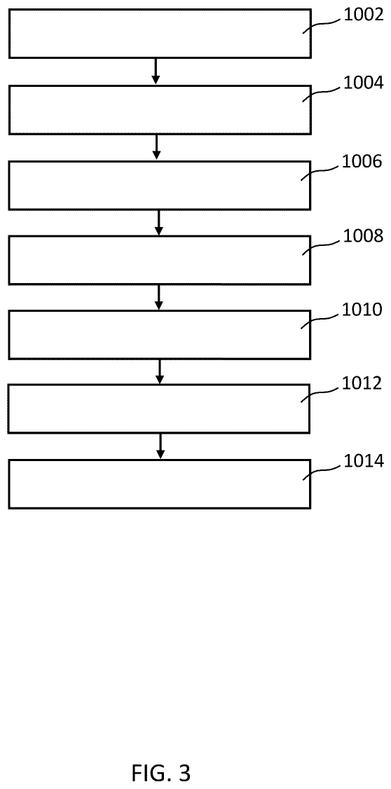

FIG. 3 is a flow chart illustrating the steps of a method of sealing a leakage path through the wall of a pipe.

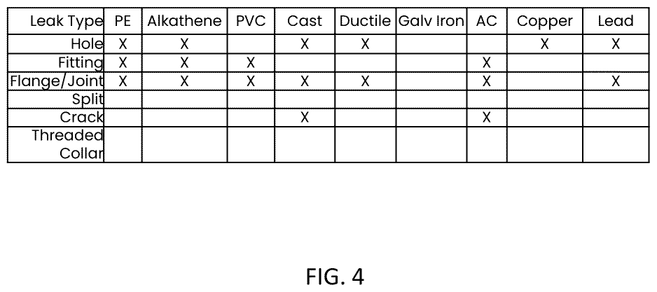

FIG. 4 is a table which shows the expected suitability of the method for sealing different types of leakage paths through different types of pipes. Pipe/leakage path types for which the method has been demonstrated to work are indicated by an ‘X’. It is expected that the method will work for pipe/leakage path types not indicated by an ‘X’. The fluid leakage may be convoluted.

At step 1002, the existence of a suspected leakage path 106 may be determined using a conventional leak detection method, such as by observation of the environment external the pipe or by surveying the inside of the pipe 102 where a leak is suspected.

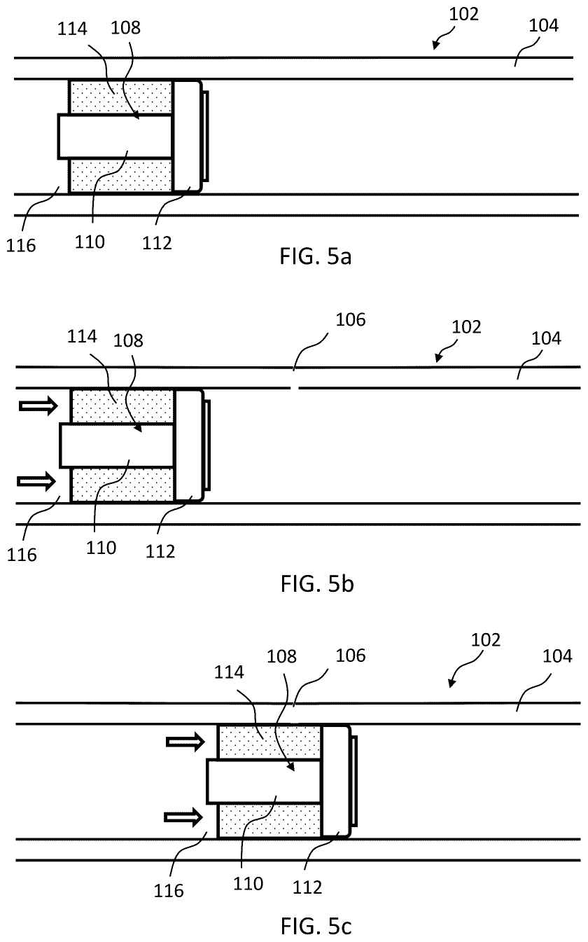

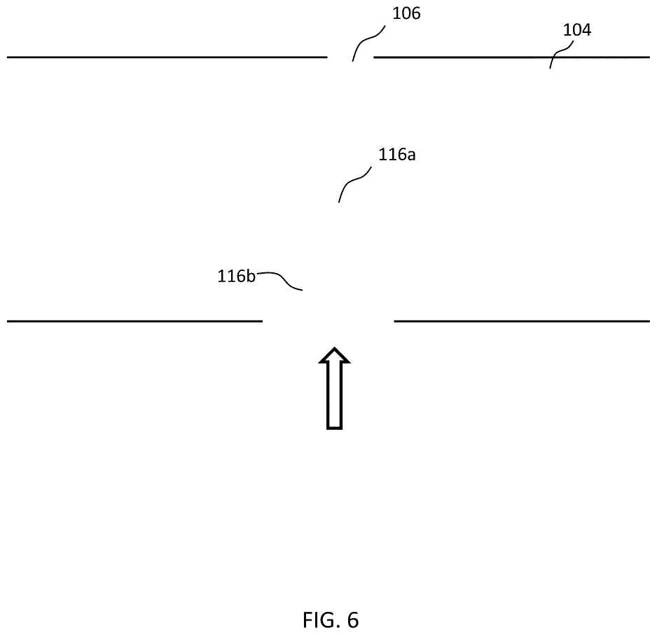

At step 1004, once a pipe 102, or section of the pipe 102 having a leak has been identified, a pig 108 may be disposed in pipe 102 at a location remote from the fluid leakage path 106, as shown in FIG. 5a. The pig 108 may be disposed in the pipe 102 by first isolating a section of the pipe 102 known to have the leak, for example by closing valves (not shown) within the pipe 102 at each end of the pipe section having the fluid leakage path. Other methods for isolating a pipe section may be used, for example, by freezing water within the pipe at separate sections along the pipe 102 so that the leakage is located between the frozen sections. In other circumstances, it may not be necessary to isolate a section of the pipe if a pig 108 can be disposed in the pipe 102 through an access point.

In the embodiment shown, the pig 108 comprises a body member 110 and an annular sealing member 112. The annular sealing member 112 is secured to the body member 110 and extends around the body member 110. The annular sealing member 112 is configured to provide a seal between the body member 110 and the pipe wall 104.

At step 1006, once the pig 108 has been inserted in to the pipe 102, a loss control composition 114 is supplied to the region of the pipe 102 behind the pig 108, as shown in FIG. 5a.

The loss control composition 114 comprises a mixture of at least one fluid in the form of a liquid, a gelling agent and particles of material. The fluid and the gelling agent combine to form a gel within which the particles of material are suspended.

In the embodiment shown, the liquid is water. The gelling agent may be a water-soluble gelling agent, as with the embodiment shown, an oil-based gelling agent, or a polymer-based gelling agent. The gelling agent may be xanthum gum which is non-toxic and so can be used safely in potable water systems. Xanthum gum is considered to be particularly suitable since it results in a loss control composition which is shear-thickening and so is particularly effective and supporting the particles of material in suspension during transportation along the pipe 102. Other suitable gelling agents which result in a shear thickening loss control composition may be used.

The particles of material may be selected from particles of mineral, including particles of a mineral having a density which is not less than 2,700 kb/m\hat{ }3. Preferably, the particles of material are made of a non-toxic mineral, such as calcium carbonate.

The particles of mineral may be selected from particles of a material having an elastic modulus not less than 5 GPa, and preferably an elastic modulus which is not less than 20 GPa. Optionally, particles of mineral may be selected from particles of a material having an elastic modulus not less than 70 GPa. Optionally, particles of calcium carbonate may be selected having an elastic modulus not less than 70 GPa and, optionally, not greater than 90 GPa.

Reference to particles having a particular ‘particle size’, for example when used in reference to mineral particulates, means a particles having no more than 10% w/w greater than the stated particle size and having no more than 10% w/w smaller than the stated particle size in mm. A particle size distribution may, in particular, be determined in accordance with ISO 13320:2020.

The composition of the loss control composition is selected based on the nature of the fluid leakage path 106, such as a selected dimension of the fluid leakage path 106. For example, the loss control composition of the loss control composition is selected to seal a fluid leakage path 106 having a selected dimension in a plane perpendicular to the depth axis Z, such as an average width of the fluid leakage path 106. The average width may be the average width of the leakage path in a plane which is perpendicular to the depth axis at which the leakage path is narrowest. This may often correspond to the section of the leakage path having the smallest cross-section flow area. Other suitable selected dimensions, such as a maximum width or minimum width, could be used. The overriding consideration is that the dimension selected should be a dimension that can be used to determine a suitable particle size for the particles of material of the loss control composition such that larger particles will be trapped by the leakage path in order to initiate sealing, as described below.

The composition of the loss control composition is arrived at by selecting a first sub-composition of particles of material having a particle size within a first predetermined range, and selecting at least a second sub-composition of particles of material having a particle size within a second predetermined range. The first and second predetermined ranges may be non-overlapping.

The first sub-composition of particles of material may have a particle size within a range that is not greater than the selected dimension of the fluid leakage path 106 and not less than 50% of the selected dimension of the fluid leakage path 106. For applications in which the selected dimension is not expected to exceed 5 mm (such as buried mains utility water-supply pipes), the particles of material may be selected from particles of material having a particle size which is not greater than 5 mm and not less than 500 microns. For example, for a selected dimension which is 4 mm (shown as dimension W in FIGS. 2a and 2b), the particles of material comprising the first sub-composition have a particle size which is not greater than 4 mm and not less than 2 mm (i.e. 50% of 4 mm).

The second sub-composition of particles of material may have a particle size within a range that is not greater than 5% of the selected dimension of the fluid leakage path 106 and optionally not greater than 1.5% of the selected dimension of the fluid leakage path 106. For applications in which the selected dimension is not expected to exceed 5 mm (such as buried water pipes), the particles of material may be selected from particles of material having a particle size which is not greater than 250 microns and not less than 15 microns. For example, for a selected dimension which is 4 mm (shown as dimension W in FIGS. 2a and 2b), the particles of material comprising the second sub-composition have a particle size which is not greater than 200 microns and preferably not less than 60 microns.

The composition of the loss control composition may comprises further sub-compositions within respective predetermined ranges. For example, the composition of the loss control composition may comprise a third sub-composition in which the particles of material have a particle size within a range that is not greater than 25% of the selected dimension of the fluid leakage path 106 and not less than 5%, and optionally not less than 3.5% of the selected dimension of the fluid leakage path 106. For applications in which the selected dimension is not expected to exceed 5 mm (such as buried water pipes), the particles of material may be selected from particles of material having a particle size which is not greater than 1.25 mm and not less than 50 microns. For example, for a selected dimension which is 4 mm, the particles of material comprising the second sub-composition have a particle size which is not greater than 1 mm and preferably not less than 200 microns.

Not less than 10% wt of the particles of material of the loss control composition are in accordance with the first sub-composition. Not less than 30% wt of the particles of material of the loss control composition are in accordance with the second sub-composition. For clarity, the proportions of the particles of material for each sub-composition are provided as proportions of the total weight of the particles of material and not as a proportion of the weight of the loss control composition.

Where the loss control composition comprises particles of material in accordance with the third sub-composition, not less than 30% wt of the particles of material of the loss control composition may in accordance with the third sub-composition.

For typical application, not more than 50% wt, and preferably not more than 30% wt of the particles of material of the loss control composition may in accordance with the first sub-composition. The remaining particles of the loss control composition are in accordance with the second, third or further sub-composition.

In practice, the composition of the loss control composition is likely to have a continuous distribution of particles of material encompassing the selected first predetermined range, the second predetermined range and third predetermined range. It will be appreciated, however, that at least a portion of the particles of material will comprise particles in accordance with each of the selected sub-compositions.

In one example, the first sub-composition has particles of material with a size not greater than 3.4 mm and not less than 500 microns. The mass-to-volume ratio of the first sub-composition is approximately 1.5 t/m\hat{ }3. The second sub-composition has particles of material with a size not greater than 1 mm and not less than 150 microns. The mass-to-volume ratio of the second sub-composition is approximately 1.6 t/m\hat{ }3. The third sub-composition has particles of material with a size not greater than 150 microns. The mass-to-volume ratio of the third composition is approximately 0.9 t/m\hat{ }3.

The mass of the particles of material mixed with 1 kg of water is used to determine the amount of gelling agent required in order to ensure that the particles of material will be suspended in the fluid. A greater amount of gelling agent results in a loss control composition having a greater viscosity and so is able to support larger particles of a material having a particular density is suspension.

The amount of gelling agent (determined in kg) per kg of water (i.e. concentration of gelling agent) required in order to suspend the particles of material increases with particle size. The amount of gelling agent must therefore be sufficient to maintain the largest particles of material in suspension. In the present context, particles are held in suspension if, during the period in which the loss control composition is used to seal a leakage path, the particles do not settle from the fluid in which they are suspended, and nor do they float upwardly to the surface of the fluid. This period is not greater than 1 day, and typically not greater than 1 hour, for example not greater than 30 minutes.

Preferably, the loss control composition comprises not less than 1 part water, not less than 0.1 part particulate, and not less than 0.05 part gelling agent by mass. Preferably, the loss control composition comprises not less than 1 part water, not more than 0.8 part particulate, and not more than 0.25 part gelling agent by mass.

At step 1008, a fluid 116, such as water, is supplied to the region of the pipe 102 behind the loss control composition 114. The fluid 116 behind the pig 108 and loss control composition 114 is held at an elevated pressure relative to the pressure of a fluid in front of the pig 108. The pressure acting on the loss control composition 114 and pig 108 (the upstream pressure) is greater that any pressure acting on the front of the pig 108 (the downstream pressure). This pressure difference may be considered to be a positive pressure difference. The supply of fluid 116 and the pressure difference propels the pig 108 and the loss control composition 114 along the pipe 102 to the portion of the pipe 102 having the fluid leakage path 106, as shown in FIG. 5b.

At step 1010, once the pig 108 has passed the portion of the pipe 102 having the fluid leakage path 106, the pig 108 is halted such that the loss control composition 114 extends along the pipe 102 over the fluid leakage path 106, as shown in FIG. 5c. The pig 108 may be halted by stopping the supply of the fluid used to propel the pig 108 along the pipe 102, or by increasing the pressure of the fluid in front of the pig 108, for example by closing a valve in the portion of the pipe 102 downstream of the pig 108, thereby equalising the pressure across the pig 108 and loss control composition 114.

At step 1012, the loss control composition 114 is pressurised by holding or increasing the pressure of loss control composition 114 at/to at least a predetermined pressure. The predetermined pressure maybe the same pressure as the elevated pressure or a greater pressure. The predetermined pressure will typically be less than 10 bar. This predetermined pressure may be applied by maintaining the fluid 116 supplied to the pipe at the elevated pressure with a valve in the portion of the pipe 102 closed, or by increasing the pressure of the fluid 116 above the elevated pressure used to propel the pig 108 and the loss control composition 114 along the pipe 102. The predetermined pressure is a predetermined expulsion pressure that is sufficient to cause the loss control composition 114 to enter the fluid leakage path 106 and propagate along at least a portion of the fluid leakage path 106. As the loss control composition 114 propagates along the fluid leakage path 106 the particles of material suspended in the fluid become trapped within the fluid leakage path 106, as shown in FIG. 6. For example, larger particles of material 116a may first become trapped in narrow sections of the fluid leakage path 106, or in particularly convoluted sections of the fluid leakage path 106. These larger particles of material 116a then form obstructions which trap smaller particles of material 116b of the loss control composition 114. As smaller and smaller particles of material become trapped within the fluid leakage path 106, the flow area through the fluid leakage path 106 reduces thereby increasingly inhibiting flow through the fluid leakage path 106. The use of sub-compositions having different particle sizes means that the particles of material do not need to be compliant in order to deform to the shape of the leakage path in order to seal the leakage path since any gaps between large particles and the walls of the leakage path are progressively obstructed by smaller particles. This allows for hard and non-elastic particles of material to be used, which can improve the robustness and longevity of the sealing provided.

During the sealing process the fluid of the loss control composition, along with any smaller particles which are not trapped in the leakage path, passes through the leakage path 106 and expelled into the surrounding environment. This allows more loss control composition 114 carrying particulate of material to enter the fluid leakage path 106. Once a sufficient quantity of particles of material of different sizes have become trapped in the fluid leakage path 106, escape of liquid through the fluid leakage path 106 is prevented or reduced to the extent that the fluid leakage path 106 can be considered to be sealed. This prevents further escape of fluid of the loss control composition 114 and also means that the fluid leakage path 106 no longer allows escape of the fluid conveyed by the pipe when it is returned to operation. For example, it is anticipated that the method can reduce the flow rate of a liquid through a leakage path 106 by up to 100% (i.e. where no liquid escapes from the pipe 102 through the fluid leakage path 106). In the context of the method, the fluid leakage path 106 is considered to be ‘sealed’ if there is at least a 95% reduction of flow rate through the fluid leakage path 106 compared against the unsealed leakage path under normal operating conditions for the pipe 102, and ‘completely sealed’ if there is a 100% reduction in flow rate (i.e. there is no escape of liquid through the fluid leakage path 106).

Sealing of the fluid leakage path 106 is therefore conducted quickly, without requiring external access to the pipe 102 in the vicinity of the fluid leakage path 106, and without requiring the loss control composition 114 to be cured.

At step 1014, once the fluid leakage path 106 has been sealed, a positive or negative pressure difference over the pig 108 is generated, and any remaining loss control composition 114, which propels the pig 108 along the pipe 102 to an access point of the pipe 102 for removal of the pig 108. The pipe 102 may then be flushed using water to remove any residual loss control composition 114.

In an alternative embodiment, the loss control composition 114 may be conveyed whilst being held under a predetermined pressure that is sufficient for the loss control composition 114 to enter and propagate along any leakage path 106 that is encountered as it travels along the pipe 102. It is therefore unnecessary to identify the location of a leakage path 106 in the pipe 102 along which the loss control composition 114 is conveyed since the loss control composition 114 will automatically enter any leakage path 106 encountered and so seal the fluid leakage path 106.

In an alternative embodiment, a gas, such as air or nitrogen, may be used to convey the pig 108 and the loss control composition 114 along the pipe 102 instead of a liquid.

In alternative embodiments, a loss control composition may be conveyed along a pipe without the use of a pig. For example, a loss control composition may be injected into a pipe as a slug. The slug is then be conveyed by supplying a fluid to the rear of the slug at an elevated pressure relative to a fluid in front of the slug in order to apply a positive pressure difference across the slug which propels the slug along the pipe. The slug may be halted at a fluid leakage path in the manner as described with respect to use of a pig and held at a pressure which is sufficient to cause the loss control composition to enter the fluid leakage path and propagate along at least a portion of the fluid leakage path thereby sealing the leakage path. In an alternative example, a pipe can be filled with a loss control composition which is then held under a pressure which is sufficient to cause the loss control composition to enter the fluid leakage path and propagate along at least a portion of the fluid leakage path thereby sealing the leakage path. In such an embodiment, the requirement for a separate fluid for conveying the loss control composition along the pipe is not required.

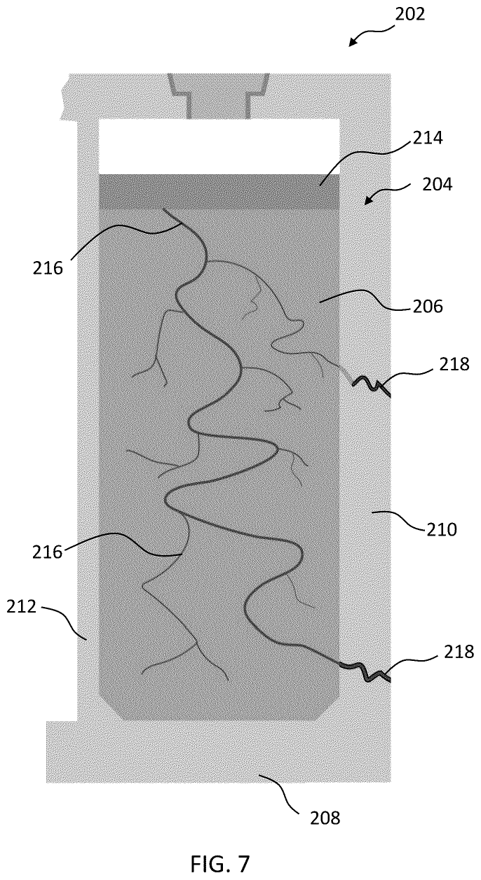

FIG. 7 shows a portion of a structure in the form of a silo 202 comprising a plurality of tanks 204 containing hazardous material, such as radioactive sludge 206. Only one tank 204 is shown in FIG. 7. The silo 202 is typical of silos used in the nuclear energy industry to store swarf stripped from nuclear fuel prior to reprocessing. The swarf may be a radioactive sludge such as sludge comprising magnesium hydroxide.

The silo 202 comprises a 1.5 m thick concrete base wall 208 and 1.4 m thick concrete side walls 210 approximately 16 m tall (only part of the silo is shown in FIG. 7). The tanks 204 are formed by compartmentalising the silo 202 using 0.6 m thick concrete internal dividing walls 212.

The silo 202 is embedded in the ground to a depth of approximately 6 m with a bitumen layer surrounding the concrete walls 210. Further forms of containment may be provided, such as a further concrete wall or free-standing shield walls (not shown).

In use, the silo 202 is used to store the radioactive sludge 206 for an indefinite period. A protective layer of water 214 (commonly referred to as ‘liquor’) is provided to cover the radioactive sludge radioactive sludge 206. In some circumstances, a silo 202 will have been used to store radioactive sludge 206 for several decades. Over this time, the radioactive sludge 206 is known to solidify, following which cracks 216 can form in it. In particular, cracks 216 can form which extend from the upper surface of the radioactive sludge 206 downwardly into the solidified radioactive sludge 206. These cracks 216 allow the water 214 covering the radioactive sludge 206 to penetrate the radioactive sludge 206.

Cracks 218 are known to form in the side walls 210, the base wall 208, and also at joins between walls of the tanks 204. Failure of sealing components, such as waterbars, can also provide leakage paths between the walls of the tank 204. The cracks/failures are typically a consequence of carbonation of steel used to reinforce the concrete walls or because of tensile or compressive stresses that arise within the structure.

In some instances, cracks 216 in the radioactive sludge 206 and the cracks 218 in the base wall 208 and/or side walls 210 connect to form leakage paths along which the water can seep through the radioactive sludge 206 and out of the tank 204 into the surrounding environment. This is undesirable.

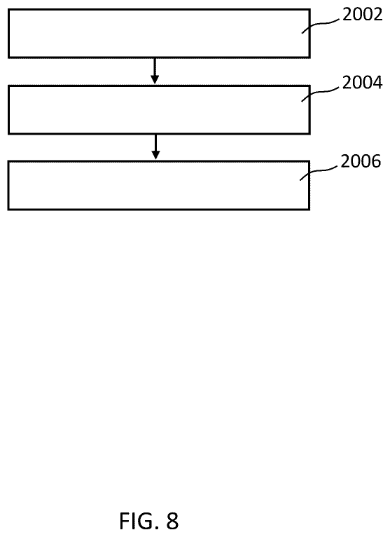

FIG. 8 is a flow chart illustrating the steps of a method of sealing a leakage path through a tank containing hazardous material, wherein the fluid leakage path extends through the hazardous material and a wall of the tank.

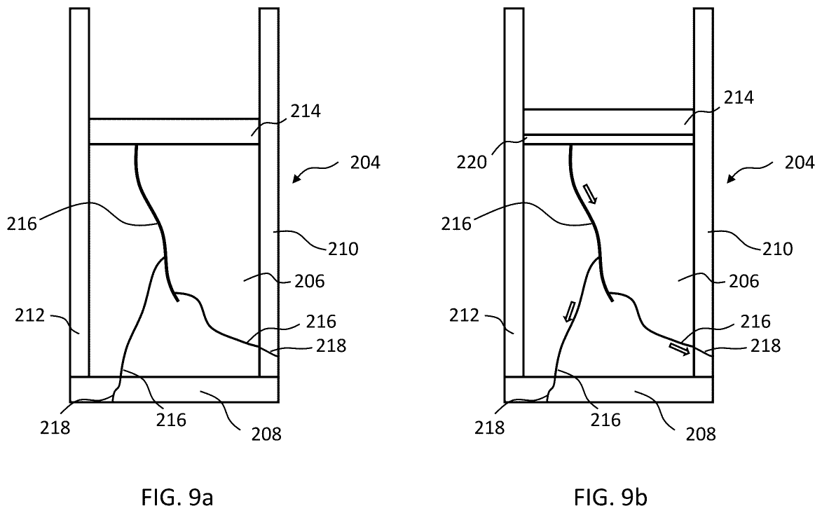

At step 2002, and with reference to FIG. 9a, a tank 204 containing a radioactive sludge 206 is identified as having a suspected leakage path through the radioactive sludge 206 and at least one side wall 210 and/or base wall 208 of the tank 204.

At step 2004, a loss control composition 220 is supplied to the upper region of the tank 204 above an upper level of the radioactive sludge 206. The loss control composition 220 may be poured into an upper region of the tank 204 above the upper level of the water 214. The composition of the loss control composition 220 is configured such that the loss control composition 220 has a density which is greater than the density of the water 214. The loss control composition 220 thus sinks below the water and spreads out on an upper surface of the radioactive sludge 206 to form a layer of loss control composition 220 on the upper surface of the radioactive sludge 206, as shown in FIG. 9b. The loss control composition 220 is a loss control composition in accordance with the loss control composition described with respect to the method illustrated in FIGS. 2 to 6. The loss control composition 220 is, however, configured to seal the fluid leakage paths through the tank 204 containing the radioactive sludge 206 by selection of particles of material having a suitable particle size and suitable amount of gelling agent.

At step 2006, the loss control composition 220 is then left to settle and maintained for at least a predetermined period of time. During this period, the loss control composition 220 seeps generally downwardly along cracks 216 that extend from the surface of the radioactive sludge 206 through the radioactive sludge 206, as indicated by the arrows shown in FIG. 9b. As the loss control composition 220 progresses along the cracks 216 it accumulates within the cracks 216, thereby inhibiting leakage of water along the cracks 216. In some circumstances, the loss control composition 220 will progress along the entire length of a crack 216 in the radioactive sludge 206 to reach a side wall 210 and/or base wall 208 of the tank 204 where it may then then enter one or more cracks 218 in the side wall 210 and/or base wall 208 and progress along said crack and accumulate within it, thereby inhibiting leakage of water along the crack 218.

It will be appreciated that a leakage path may be sealed by either preventing water from seeping along the full length of a crack 216 in the radioactive sludge 206 and/or preventing water from escaping through a crack 218 in the base wall 208 or wall 210 of the tank 204.

The described method may be used to seal leakage paths in walls of other structures, such as structures that are capable of containing, retaining or conveying a fluid, particularly a liquid. All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed. Features and selection process of the first aspect of the invention may be used or adapted for use with the second aspect of the invention as appropriate.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims are generally intended as “open” terms (e.g., the term “including” or “comprising” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

It will be appreciated that various embodiments of the present disclosure have been described herein for purposes of illustration, and that various modifications may be made without departing from the scope of the present disclosure. Accordingly, the various embodiments disclosed herein are not intended to be limiting, with the true scope being indicated by the following claims.

1. A method of sealing a fluid leakage path through a wall of a structure comprising the steps:
supplying a loss control composition to a region of a wall of a structure having a fluid leakage path; and
causing the loss control composition to enter and propagate along at least a portion of the fluid leakage path, the loss control composition comprising a mixture of at least one fluid and particles of material suspended in the fluid, wherein the particles of material are configured to become trapped within the fluid leakage path as the loss control composition propagates along the at least a portion of the fluid leakage path such that the particles of material accumulate within the fluid leakage path thereby sealing the fluid leakage path.

2. The method of claim 1, wherein the loss control composition further comprises a gelling agent which combines with the fluid to form a gel.

3. The method of claim 1, wherein the fluid comprises a liquid.

4. The method of claim 3, wherein the liquid comprises water.

5. The method of claim 1, wherein the loss control composition comprises not less than 1 part water, not less than 0.1 part particulate, and not less than 0.05 part gelling agent by mass.

6. The method of claim 1, wherein the loss control composition comprises not less than 1 part water, not more than 0.8 part particulate, and not more than 0.25 part gelling agent by mass.

7. The method of claim 2, wherein the gelling agent comprises at least one of a water-soluble gelling agent, an oil-based gelling agent and a polymer-based gelling agent.

8. The method of claim 1, wherein the particles of material comprise particles of material that have an elastic modulus not less than 5 GPa, and optionally not less than 20 GPa.

9. The method of claim 1, wherein the particles of material comprise particles of material that are mineral.

10. The method of claim 1, wherein the loss control composition has a composition in which particles of material comprise particles of material having a particle size which is not greater than 5 mm.

11. The method of claim 1, wherein the loss control composition comprises a first sub-composition in which the particles of material have a particle size within a first predetermined range and a second sub-composition in which the particles of material have a particle size within a second predetermined range.

12. The method of claim 11, wherein the first predetermined range and the second predetermined range are non-overlapping ranges.

13. The method of claim 11, wherein the loss control composition comprises not less than 10% wt of the first sub-composition.

14. The method of any one of claims 11, wherein the loss control composition comprises not more than 50% wt of the first sub-composition.

15. The method of any one of claims 11, wherein the loss control composition comprises not less than 30% wt of the second sub-composition.

16. The method of any one of claims 11, wherein the first sub-composition comprises particles having a particle size within a range that is not greater than 5 mm and not less than 500 microns.

17. The method of any one of claims 11, wherein the second sub-composition comprises particles having a particle size within a range that is not greater than 250 microns and not less than 15 microns.

18. The method of any one of claims 11, wherein the fluid leakage path has a selected dimension and the first sub-composition of particles of material may have a particle size within a range that is not greater than the selected dimension and not less than 50% of the selected dimension.

19. The method of any one of claim 18, wherein the second sub-composition of particles of material may have a particle size which is not greater than 5% of the selected dimension.

20. The method of claim 1, wherein the particles of material are particles of a material having a density which is not less than 2700 kg/m\hat{ }3.

21. (canceled)

22. (canceled)

23. (canceled)

24. (canceled)

25. (canceled)

26. (canceled)

27. (canceled)
